(19) United States
(12) Patent Application Publication
(10) Pub. No.: US 2016/0260294 A1
(43) Pub. Date: Sep. 8, 2016

(54) MULTI-PLAY BACCARAT

(71) Applicant: Las Vegas Sands Corp., Las Vegas, NV (US)

(72) Inventors: Justin BELTRAM, Las Vegas, NV (US); Eric PERSSON, Las Vegas, NV (US); Andrzej SURMACZ, Las Vegas, NV (US)

(21) Appl. No.: 14/639,074

(22) Filed: Mar. 4, 2015

(51) Int. Cl. G07F 17/32

(52) U.S. Cl. CPC G07F 17/3293; G07F 17/3244; G07F 17/3211

(57) ABSTRACT

In playing multiple hands of baccarat, indication of a first wager and a first selection by a user is received, the first selection for a player win, a banker win or a tie for a first hand of baccarat. Indication of a second wager and a second selection by the user is received, the second selection for a player win, a banker win or a tie for a second hand of baccarat. Input by the user is received, to deal the first hand and the second hand based on the respective first wager and second wager, and on the respective first selection and second selection. In response to the received user input, the first hand and the second hand of baccarat are dealt. For each of the first and second hands, an outcome is determined based on the respective first wager and second wager, and based on the respective first selection and the second selection.

### BACKGROUND

In casino games, wagers (or “bets”) are placed on the possible outcomes of a game, and a payout for the game may be based on the amount of the wager in addition to the odds of the wagered event occurring within the game or other event. In an example game of baccarat, two cards are dealt face up to each of two hands, the “player” and the “banker,” starting from “player” and alternating between the hands. Single digit cards (e.g., 2-9) are given their face value in points, Aces are worth 1 point, and 10s, Jacks, Queens, and Kings are worth zero. The value of a hand is equal to the rightmost digit of the sum of the cards. If the player, banker, or both achieve a total of eight or nine after the initial draw, the result is announced: “player win,” a “banker win,” or “tie.” Otherwise, drawing rules are applied to determine whether the player should receive a third card. Then, based on the value the newly-drawn card, drawing rules are applied to determine whether the banker should receive a third card. The outcome is then announced and winning bets are paid out according to different odds given for each possible result.

### SUMMARY

The disclosed subject matter relates to a method for playing multiple hands of baccarat. The method comprises receiving indication of a first wager and a first selection by a user, the first selection for a player win, a banker win or a tie for a first hand of baccarat. The method further comprises receiving indication of a second wager and a second selection by the user, the second selection for a player win, a banker win or a tie for a second hand of baccarat. The method further comprises receiving input by the user to deal the first hand and the second hand based on the respective first wager and second wager, and on the respective first selection and second selection, and dealing, in response to the received input by the user, the first hand and the second hand of baccarat. The method further comprises determining, for each of the first and second hands, an outcome based on the respective first wager and second wager, and based on the respective first selection and second selection.

The disclosed subject matter also relates to a system for playing multiple hands of baccarat, comprising one or more processors, and a machine-readable medium comprising instructions stored therein, which when executed by the processors, cause the processors to perform operations. The operations comprise receiving indication of a first wager and a first selection by a user, the first selection for a player win, a banker win or a tie for a first hand of baccarat, and receiving indication of a second wager and a second selection by the user, the second selection for a player win, a banker win or a tie for a second hand of baccarat. The operations further comprise receiving input by the user to deal the first hand and the second hand based on the respective first wager and second wager, and on the respective first selection and second selection, and dealing, in response to the received input by the user, the first hand and the second hand of baccarat. The operations further comprise determining, for each of the first and second hands, an outcome based on the respective first wager and second wager, and based on the respective first selection and second selection.

The disclosed subject matter also relates to a system for playing baccarat, the system comprising one or more processors and a machine-readable medium comprising instructions stored therein, which when executed by the processors, cause the processors to perform operations. The operations comprise displaying a graphical interface for playing at one or more virtual tables of baccarat, and receiving, via the graphical interface, user input specifying that a bet be placed for a prediction of a banker win, a player win or a tie for the one or more virtual tables. The operations further comprise accessing, in response to the received user input, a data structure corresponding to a hand history, the hand history comprising prior hands of baccarat played in association with the one or more virtual tables, and determining, based on the hand history, the prediction of the banker win, the player win or the tie for the one or more virtual tables. The operations further comprise automatically placing a bet for each of the one or more virtual tables, based on the prediction of the banker win, the player win or the tie for the one or more virtual tables, wherein the one or more placed bets are displayed within the graphical interface, and dealing a hand of randomly-generated cards for each of the one or more virtual tables using a random number generator, wherein the one or more dealt hands are displayed within the graphical interface. The operations further comprise determining, for each of the one or more dealt hands, an outcome based on the respective randomly-generated cards and the respective automatically placed bet for the table, and displaying, via the graphical interface, the determined outcome for each of the one or more dealt hands.

The disclosed subject matter also relates to a method for playing baccarat. The method comprises displaying a graphical interface for playing at one or more virtual tables of baccarat, and receiving, via the graphical interface, user input specifying that a bet be placed for a prediction of a banker win, a player win or a tie for the one or more virtual tables. The method further comprises accessing, in response to the received user input, a data structure corresponding to a hand history, the hand history comprising prior hands of baccarat played in association with the one or more virtual tables, and determining, based on the hand history, the prediction of the banker win, the player win or the tie for the one or more virtual tables. The method further comprises automatically placing a bet for each of the one or more virtual tables, based on the prediction of the banker win, the player win or the tie for the one or more virtual tables, wherein the one or more placed bets are displayed within the graphical interface, and dealing a hand of randomly-generated cards for each of the one or more virtual tables using a random number generator, wherein the one or more dealt hands are displayed within the graphical interface. The method further comprises determining, for each of the one or more dealt hands, an outcome based on the respective randomly-generated cards and the respective automatically placed bet for the table, and displaying, via the graphical interface, the determined outcome for each of the one or more dealt hands.

The disclosed subject matter also relates to a system for playing baccarat, the system comprising one or more processors and a machine-readable medium comprising instructions stored therein, which when executed by the processors, cause the processors to perform operations. The operations comprise receiving indication of a predetermined pattern for identifying in association with multiple baccarat hands, and displaying a graphical interface for playing at one or more virtual tables of baccarat. The operations further comprise accessing a data structure corresponding to a hand history, the hand history comprising prior hands of baccarat played in association with the one or more virtual tables, and identifying the predetermined pattern within the hand history, based on a comparison of the predetermined pattern to the prior hands of baccarat in the hand history. The operations further comprise providing for at least one bet to be placed based on identifying the predetermined pattern, wherein the at least one placed bet is displayed within the graphical interface, and dealing a hand of randomly-generated cards for the at least one placed bet using a random number generator, wherein the at least one dealt hand is displayed within the graphical interface. The operations further comprise determining, an outcome for the at least one dealt hand based on the randomly-generated cards for the dealt hand and the at least one placed bet, and displaying, via the graphical interface, the determined outcome for the at least one placed bet.

The disclosed subject matter also relates to a method for playing baccarat. The method comprises receiving indication of a predetermined pattern for identifying in association with multiple baccarat hands, and displaying a graphical interface for playing at one or more virtual tables of baccarat. The method further comprises accessing a data structure corresponding to a hand history, the hand history comprising prior hands of baccarat played in association with the one or more virtual tables, and identifying the predetermined pattern within the hand history, based on a comparison of the predetermined pattern to the prior hands of baccarat in the hand history. The method further comprises providing for at least one bet to be placed based on identifying the predetermined pattern, wherein the at least one placed bet is displayed within the graphical interface, and dealing a hand of randomly-generated cards for the at least one placed bet using a random number generator, wherein the at least one dealt hand is displayed within the graphical interface. The method further comprises determining, an outcome for the at least one dealt hand based on the randomly-generated cards for the dealt hand and the at least one placed bet, and displaying, via the graphical interface, the determined outcome for the at least one placed bet.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example apparatus for simulating play of an example card game.

FIG. 2 illustrates an example of a graphical user interface for playing at one or more virtual tables of baccarat.

FIG. 3 illustrates an example graphical user interface in which one or more hands of baccarat are dealt.

FIG. 4 illustrates an example graphical user interface with a hand history for baccarat.

FIG. 5 illustrates an example of the different icons that may appear within a bead road for baccarat hands.

FIG. 6 illustrates an example of a bead road for baccarat hands.

FIG. 7 illustrates an example of a big road and a corresponding bead road for baccarat hands.

FIG. 8 illustrates an example of a big road for baccarat hands.

FIG. 9 illustrates another example of a big road for baccarat hands.

FIG. 10 conceptually illustrates a relation between a big eye road, a small road and a cockroach road for baccarat hands.

FIG. 11 illustrates an example for a big eye road, a small road and a cockroach road for baccarat hands.

FIG. 12 illustrates another example for a big eye road, a small road and a cockroach road for baccarat hands.

FIG. 13 illustrates an example of road probing for a next round of baccarat.

FIG. 14 illustrates an example of a bead road for baccarat hands where the bead road becomes full.

FIG. 15 illustrates an example of a road in which a column turns right after having more than 6 icons.

FIG. 16 illustrates another example of a road in which a column turns right.

FIG. 17 illustrates another example of a road in which a column turns right.

FIG. 18 illustrates an example of a road in which the whole road shifts left by a column.

FIG. 19 illustrates an example process by which baccarat is played.

FIG. 20 illustrates another example process by which baccarat is played.

FIG. 21 illustrates yet another example process by which baccarat is played.

FIG. 22 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details.

The subject disclosure provides for a system directed to an electronic version of baccarat, which is fully automated at an electronic table game (ETG) and allows a player to play one or more hands of baccarat (e.g., 1 to 8 hands) concurrently. Each hand is provided through a self-contained random number generator (RNG). In example aspects, the baccarat game is implemented as a stand-alone unit, with the RNG being self-contained within an electronic gaming machine board and an individual cabinet. The player will be allowed to select 1 to n tables (e.g., n=8) to place wagers on as the baccarat hands are dealt.

For example, to play multiple hands of baccarat, indication of a first wager and a first selection by a user is received, the first selection for a player win, a banker win or a tie for a first hand of baccarat. Indication of a second wager and a second selection by the user is received, the second selection for a player win, a banker win or a tie for a second hand of baccarat. Input by the user is received, to deal the first hand and the second hand based on the respective first wager and second wager, and on the respective first selection and second selection. In response to the received user input, the first hand and the second hand of baccarat are dealt. For each of the first and second hands, an outcome is determined based on the respective first wager and second wager, and based on the respective first selection and the second selection.

In example aspects, the baccarat game permits the player to bet using a “best guess” feature, which is an algorithm within the system that allows the player to bet on the most probable winning hand based on prior games. The system predicts whether the current hand(s) will be a banker win, a player win, or a tie. Thus, instead of the player manually selecting banker win, player win, or tie, the selection of banker, player or tie is automatically determined by the system, based on hand history. For example, the automatic determination is based on the outcomes of prior hands dealt within the current shoe, which includes 6 or 8 virtual decks.

For example, a graphical interface for playing at one or more virtual tables of baccarat is displayed. User input specifying that a bet be placed for a prediction (e.g., “best guess”) of a banker win, a player win or a tie for the one or more virtual tables is received via the graphical interface. In response to the received user input, a data structure corresponding to a hand history is accessed, the hand history comprising prior hands of baccarat played in association with the one or more virtual tables. Based on the hand history, the prediction of the banker win, the player win or the tie for the one or more virtual tables is determined. A bet is automatically placed for each of the one or more virtual tables, based on the prediction of the banker win, the player win or the tie for the one or more virtual tables, where the one or more placed bets are displayed within the graphical interface. A hand of randomly-generated cards is dealt for each of the one or more virtual tables using a random number generator, where the one or more dealt hands are displayed within the graphical interface. For each of the one or more dealt hands, an outcome is determined based on the respective randomly-generated cards and the respective automatically placed bet for the table. The determined outcome for each of the one or more dealt hands is displayed via the graphical interface.

Alternatively or in addition, the system can automatically determine trends based on prior hands, and can place bets or prompt for bets based on the determined trends. For example, in the event of seven or more consecutive player or banker wins (e.g., known as a “dragon tail”), an automatic bet can be placed, or the player can be notified of the dragon tail and prompted to bet. The types of trends, automatic betting and prompting can be selectable options specified by the player.

For example, indication of a predetermined pattern (e.g., trend) for identifying in association with multiple baccarat hands is received. A graphical interface for playing at one or more virtual tables of baccarat is displayed. A data structure corresponding to a hand history is accessed, the hand history comprising prior hands of baccarat played in association with the one or more virtual tables. The predetermined pattern is identified within the hand history (e.g., a dragon tail is detected), based on a comparison of the predetermined pattern to the prior hands of baccarat in the hand history. At least one bet is placed (e.g., based on input in response to a displayed prompt, or the bet is automatically placed without prompting) based on identifying the predetermined pattern, where the at least one placed bet is displayed within the graphical interface. A hand of randomly-generated cards is dealt for the at least one placed bet using a random number generator, where the at least one dealt hand is displayed within the graphical interface. An outcome for the at least one dealt hand is determined based on the randomly-generated cards for the dealt hand and the at least one placed bet. The determined outcome for the at least one placed bet is displayed via the graphical interface.

The term “game” or “games” as used herein encompasses various opportunities for a player (or “user”) to wager on the results or outcome of an event, and/or on a specific occurrence. For example, wagering may occur in games such in a card game in which the event may be a dealing and/or revealing of one or more cards to the player(s), the opponent (e.g., bank(er), or both. The outcome may be associated with odds that the cards will be dealt in one of multiple combinations to a player, the opponent, or both, and further may be associated with a payout payable on the occurrence of the wagered event. In one example, the payout may be calculated based on the amount of the bet and/or the odds. Odds of winning the wager and/or the payout of a wager placed on a game may be dependent on or independent from the number of players in the game. In one example, any number of players wagering on the game may be personally located at the game and/or may place a wager remotely according to the processes described herein.

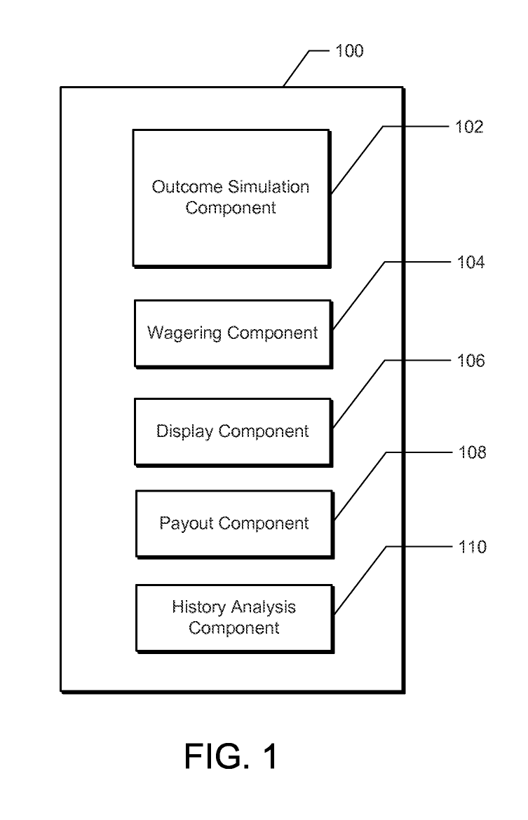

FIG. 1 illustrates an example apparatus 100 for simulating play of an example card game (e.g., baccarat) according to one or more implementations of the subject technology. The various components of the apparatus 100 may be implemented as a processor-based game console. For example, apparatus 100, may be a single console or terminal for allowing a single player to one or more hands of baccarat, with the baccarat game being simulated by software or firmware executing on apparatus 100.

Apparatus 100 may be implemented as a stand-alone unit, with an RNG for dealing baccarat hands being self-contained within an electronic gaming machine board and an individual cabinet. The one or more components of apparatus 100 may be communicatively coupled to one either via wired or wireless connection.

In an example embodiment, apparatus 100 can be a made up of multiple stations or terminals allowing multiple players to play a card game (e.g., baccarat) being simulated by the apparatus 100, including for example, each player wagering on one or more potential game outcomes.

In an example embodiment, apparatus 100 may be a client device in a client-server environment, including a client application for playing the card game in a virtual environment. In this manner, the client application may be installed at apparatus 100 and/or otherwise accessible at apparatus 100 by a user (e.g., through a browser or web-enabled component application installed on apparatus 100). Apparatus may be a mobile device (e.g., a smart-phone or notebook or tablet computer). The user may download the application onto apparatus 100 and/or access the application, for example, using a browser installed at apparatus 100.

Apparatus 100 includes game circuitry, which implements one or more of an outcome simulation component 102, a wagering component 104, a display component 106, a payout component 108 and a history analysis component 110. Outcome simulation component 102 may include one or more RNGs in one or more sets, for simulating one or more game outcomes (e.g., outcomes that players can wager on). For example, outcome simulation component 102 may include an electronic RNG for dealing of a set of cards used in a baccarat game. The electronic RNG may generate, for example, random cards for multiple virtual tables of baccarat, where each hand is based on a virtual eight-deck shoe of cards. As such, in example aspects, a separate instance of an RNG may be used for each of the multiple hands, where each instance of the RNG deals randomly-generated cards based on an eight-deck shoe. As cards are used, the RNG may remove the used cards from play so that they are not re-generated (e.g., in an eight deck shoe, after dealing the first Ace of Spades, 7 more of this card would remain).

Outcome simulation component 102 may select a set of cards from one or more predetermined virtual decks according to a predetermined rule. Each deck may include a predetermined number of cards of a certain suit or values. For example, a deck of cards may include fifty-two standard playing cards of four different suits. In various aspects, Jokers may be omitted from the deck. The total number of cards selected for a card game may be based on a predetermined value, for example, set by a croupier or sponsor of the game (e.g., by a casino). In one or more implementations, outcome simulation component 102 may randomly select cards from a randomized deck of cards for use in baccarat.

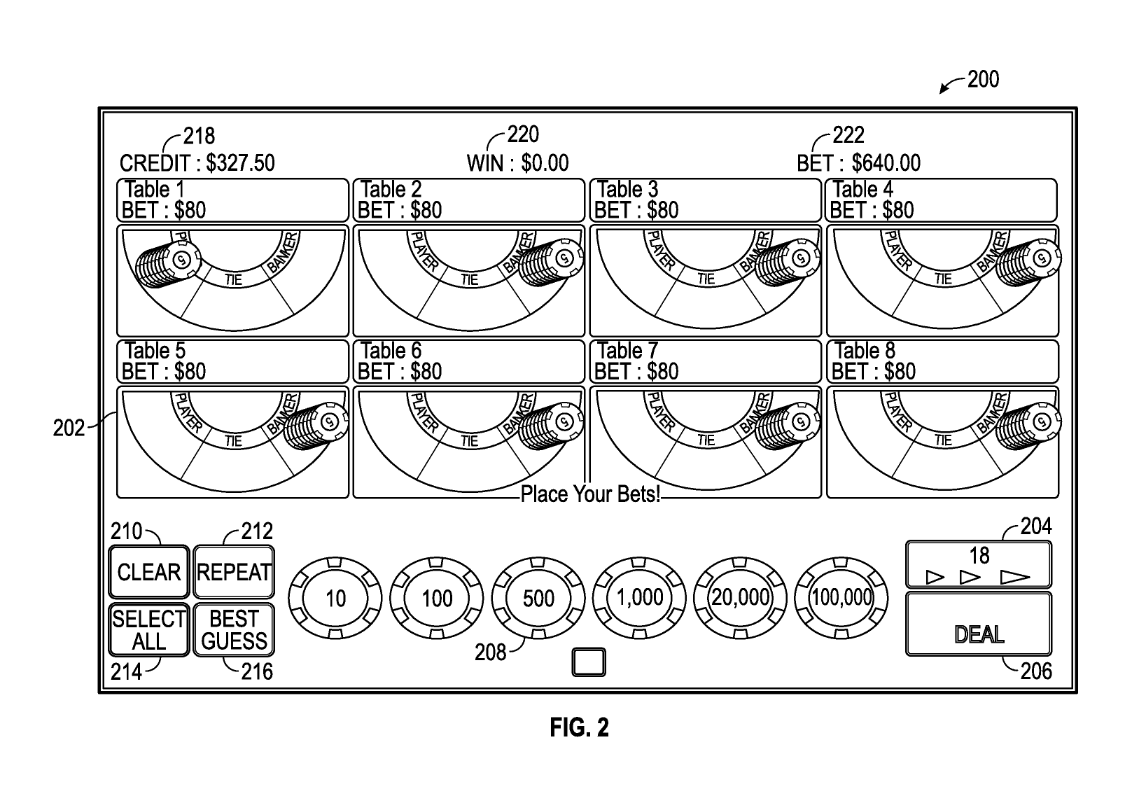

Wagering component 104 may include or be associated with one or more wagering mechanisms for facilitating placing wagers (or “bets”) on the possible outcomes of cards selected by outcome simulation unit 102. In some implementations, the wagering mechanisms may, for example, include one or more of machine implemented buttons, one or more touch screens or portions thereof, and/or include other machine-implemented mechanisms for placing wagers, initiating the dealing of a new set of cards, initiating rounds of play, and/or otherwise taking part in a game or round of play of the game simulated using apparatus 100. For example, FIG. 2 which is described in greater detail below, illustrates various examples of a graphical user interface for providing information about a baccarat game to a player and/or facilitating play of baccarat by way of virtual wagering mechanisms implemented as virtual buttons on a touch screen. Accordingly, these virtual wagering mechanisms may enable a single player to place wagers on potential outcomes related to cards generated by outcome simulation component 102 and/or selected by the player.

If the user is a new player, the user may be requested to provide information such as name, contact information, gaming preferences, and/or financial banking information. Such information may be used to create a user account used to conduct wagers for the card game. The account may be maintained in accordance with applicable requirements, rules and/or regulations for gaming and/or financial accounts.

Display component 106 may include one or more displays for providing game-related information and graphics to the player. For example, display component 106 may include a main display for displaying game information such as game outcomes, wagering results, a visual representation of the randomizer unit(s) of the outcome simulation component 102, information and data from the outcome simulation component 102, hand history, and/or wagering information from the wagering component 104. Wagering component 104 and main display of display component 106 may be implemented as a graphical interface as depicted by FIGS. 2-4. In one or more implementations, display component 106 may include touch screen capabilities for allowing a player to place wagers.

In various aspects, display component 106 may include a main display and one or more secondary displays for displaying various images, videos or other visual indicia relating to the game, advertisements, marketing material, or other visual images or videos for display to the player. The main display and/or secondary display may include one or more of a touch screen display, a panel, a holographic display, a screen (e.g., LED or LCD) or other display. One or more displays of display component 106 (e.g., the main display and/or secondary displays) may include a tablet or other mobile display mechanism operably connected to apparatus 100 and used by the player.

Payout component 108, in one example, may be configured to settle wages placed, for example, using the wagering component 104, according to the outcome generated, for example, by the outcome simulation component 102. In one example, the wagering component may have access to data regarding particular returns for particular wagers relating to a specific game. In some examples, the payout component may further have access to rules and/or regulations regarding settling of wagers and/or payouts in one or more games. In one or more implementations, payout component 108 may be connected to and work in conjunction with an electronic voucher system for providing payout by printed voucher. Alternatively or in addition, payout component 108 may include or be operably connected to a physical payout dispenser or distributer for distribution of game tokens/cash to the player(s).

History analysis component 110 may be configured to analyze the history of prior hands (e.g., baccarat hands), for example, in order to predict the outcome of one or more hands to be dealt. Such prediction may correspond to a best guess feature. History analysis component 110 may be further configured to analyze the history of prior hands in order to determine if a predetermined pattern has occurred, or is close to occurring, within the history of prior hands. If such determination is made, history analysis component 110 can be used to automatically place a bet, prompt the user to bet, or notify the user of the pattern (e.g., or nearly completed pattern).

FIG. 2 illustrates an example of a graphical user interface for playing at one or more virtual tables of baccarat. For example, graphical interface 200 may be provided by display component 106 in association with playing at one or more virtual tables of baccarat. In example aspects, graphical interface 200 is presented on a touchscreen display which permits a user to interact with the different input elements of graphical interface 200. The input elements (e.g., touch input elements) of graphical interface 200 can include, but are not limited to, tables 202 for betting on one or more hands of baccarat, timer 204, deal button 206, chip options 208, clear button 210, repeat bet button 212, select all button 214, best guess button 216, credit indication 218, win indication 220 and bet indication 222.

Graphical interface 200 provides the user with an option to play on any of multiple (e.g., eight) presented tables 202, each of which corresponds to a virtual baccarat table. It should be noted that eight hands is one example of the maximum number of hands to play per game, and that the subject disclosure is not limited to such. For example, the maximum number of hands can be set at 4, 6, 12, 20 or another integer value. The maximum number of hands may be adjusted via a separate interface, for example, by a croupier or sponsor of the game (e.g., by a casino).

Using apparatus 100 (e.g., with a captive touch device), the user may then select a wager amount from one of the multiple (e.g., six) chip options 208 available on the screen. Once selected, the chip(s) maybe dragged to the desired table from tables 202 and corresponding bet option (e.g., banker, user or tie) for that table. Alternatively, the user may select the chip(s) from chip options 208, and then select the desired table from tables 202 and bet options (e.g., banker, user or tie) by tapping the screen. Each table of tables 202 may have a minimum bet based on the game configuration. The selection of wagers/bets can be made in association with wagering component 104. Once a chip has been placed on a table, the table will reflect the total amount wagered for that table and bet, for example, as bet indication 222. As shown in the example of FIG. 2, the user has selected different bets for each of respective tables 202.

After all wagers/bets have been placed, the user may then manually end the game by pressing the deal button 206. By pressing deal button 206, all placed bets are committed and randomly-generated hands are dealt (e.g., using respective RNGs associated with outcome simulation component 102). Alternatively or in addition, if the user fails to have all wagers placed before the game count down timer 204 ends, the user wagers only account for what is placed on the tables 202, and all other wagers will have to wait until next game play to place wagers. In example aspects, the time limit can be set by a croupier or sponsor of the game (e.g., by a casino). The user may have the option to speed up the game count down timer, for example, pressing a corresponding button for timer 204. This button has three set speed options (e.g. indicated by arrows for element 204 in FIG. 2) that maybe cycled through each time the button is pressed.

Credit indication 218 depicts the user's available credit for betting, win indication 220 depicts an amount of winnings (e.g., from the current hands, if applicable), and bet indication 222 depicts a sum total of all placed bets. Credit indication 218, win indication 220 and bet indication 222 can be updated in real time, as bets are placed by the user and hand outcomes are determined.

Graphical interface 200 may include additional buttons (not shown). For example, selecting a help and information button will display help screen and game play information. Selecting a cash out button will remove all credits from the machine and return the credits back to the user (e.g., in association with payout component 108). Selecting a call attendant button will signal an attendant for assistance.

Graphical interface 200 further includes best guess button 216. By selecting the best guess button 216, the user specifies that the system itself, for example in association with the history analysis component 110, is to predict whether a hand (e.g., corresponding to tables 202) will be a banker win, a player win, or a tie. The best guess feature may be used on per-table basis, where the user selects which of the 8 tables for which a prediction is made. Alternatively, the best guess feature may be applied to all 8 tables for a game, such that a bet is placed using the prediction of the system for all 8 hands. The user may select different bet amounts for the predictions of the best guess feature, for example, using the betting chips 208 interface.

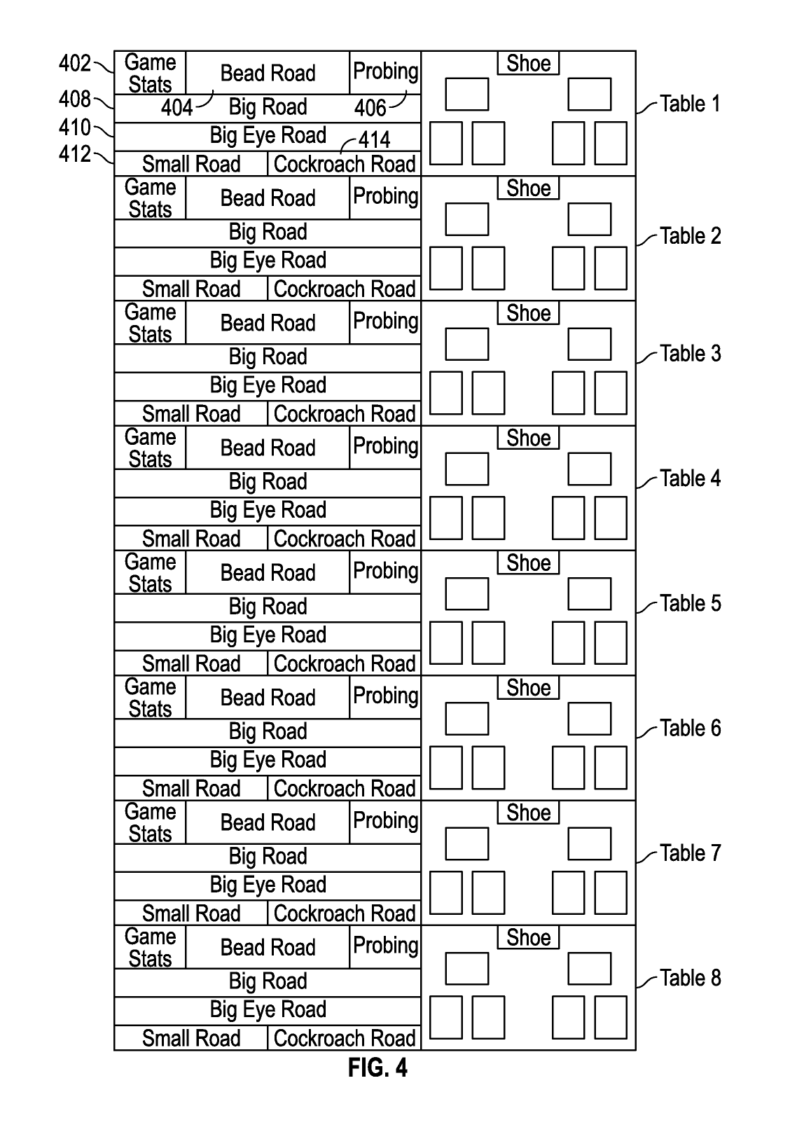

In example aspects, the best guess logic (e.g., associated with history analysis component 110) for predicting a banker win, player win or tie is based off of prior hand history corresponding to trending roadmap data. In this regard, trending roadmap data is described in greater detail below with respect to FIGS. 4-18.

By way of summary, roadmap data from the “big eye road,” “small road,” and “cockroach road” can be used to predict the outcome of upcoming baccarat hands. These roads are generated from data corresponding to the “big road.” Each of these roads can be accessed and/or stored in memory in association with one or more data structures (e.g., in association with history analysis component 110), and can further be updated in real time (e.g., where the outcome of a current hand is used to update the roads). Using the roadmap data as accessed from the one or more data structures, a prediction or next play icon is determined based on if the next play is a banker or a player.

The big eye, small and cockroach roads can correspond to tables that represent how consistent the big road is. When the big road has a repeating pattern, then each one of the big eye, small and cockroach roads will derive if the big road is consistent or not. Each road has a unique set of logic to determine consistency. Consistency is displayed in one manner (e.g., as a red color), where inconsistency is displayed in a different manner (e.g., as a blue color).

Based on the history of the big eye, small, and cockroach roads, the best guess logic will compare the outcomes. If the history shows that the table (e.g., prior rounds of baccarat hands) is inconsistent, the best guess logic (e.g., associated with button 216) will calculate the best guess for inconsistency. If the history shows that the table (e.g., prior rounds of baccarat hands) is consistent, the best guess logic will calculate the best guess for consistency. If the next outcome will make one or more of these tables match the consistency of the previous history, then the best guess logic will place a wager on the outcome that matches the previous trending information of the two bets. If the next play is the same for both bets, on the banker as it is for the player, then based on the odds of the game, banker can always be chosen as the best guess.

While not shown in FIG. 2, graphical interface 200 may further provide for prompting the user to bet when a predetermined pattern (e.g., trend) has occurred or is about to occur. For example, in the game of baccarat, a player may prefer specific trends that succumb to their superstition or perceived luck. When their preferred trend naturally occurs, they will begin to play or increase their bet. Within the baccarat game of the subject disclosure, the player allowed to identify their preferred trends via a graphical interface (e.g., where the user preselects preferred trends or patterns). As the ongoing baccarat hands are dealt, the player will be prompted when their identified trend(s) occurs on any one of the multiple games. In example aspects, the user may also be presented with a pre-notification when the trend is close to materializing (e.g., based on reaching a threshold amount of similarity when compared to the preselected trend).

In example aspects, apparatus 100 (e.g., with a captive touch device) is only used as an input device. All games will be displayed on a main screen display, including cards dealt, table min and max, game information, and all road map information. If the user is not playing one of the eight tables 202, then the table will be displayed as not in play. The games however, will continue to be simulated showing trending road map information. The user may place a wager on any table if the game count down timer 204 has not expired.

After the game ends, the tables are cleared and the user must then wager again. If the user desires to repeat the bet for all tables, the repeat button 210 will wager the exact wagers from the previous game. The user may then add additional wagers if desired.

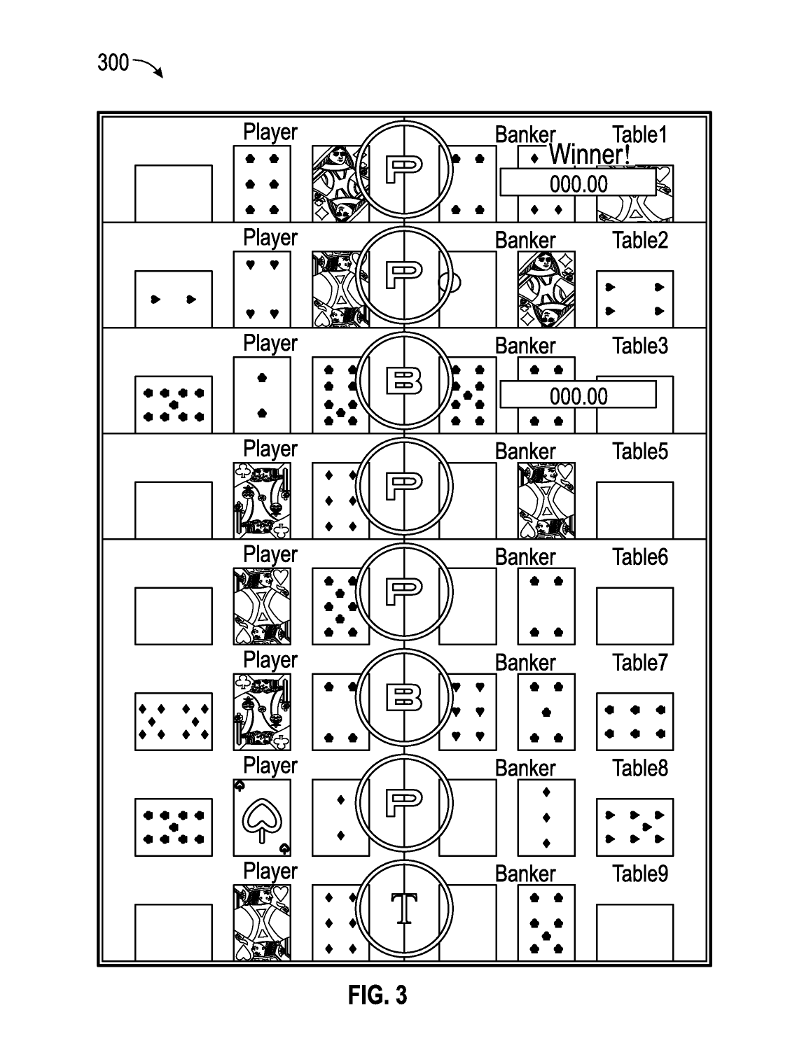

FIG. 3 illustrates an example graphical user interface in which one or more hands of baccarat are dealt. As noted above with reference to FIG. 2, hands of baccarat can be dealt by user selecting deal button 206 or at the expiration of timer 204. As noted, bets can be manually placed by the user or made in association with a best guess selection. Upon selecting button 206 or expiration of timer 204, the placed bets are committed and outcome simulation component 102 uses one or more instances of an electronic RNG to deal the one or more hands of baccarat selected by the user.

With reference to how cards are dealt and winning hands determined, an explanation of baccarat gameplay will now be provided. In example aspects, the game consists of a predetermined number of decks (e.g., 8) per shoe, and only two hands are dealt. One hand is designated the banker hand while the other is the player hand. The user may bet on either the banker hand, player hand, or if they will tie.

Two cards are dealt for each hand. The total points will determine if the hand receives a third card. Points are based on the rank of the card, with an ace being one point, and numerical cards (e.g., 2 to 9) having their respective value up to nine points. Any card that is ten, jack, queen, and king is ten, but is worth zero points. The player hand is dealt to first and is completed first. Any hand dealt that is over ten will be worth the points minus ten. For example, if the player is dealt a five and a nine the players hand totals fourteen but is only worth four points.

If the player has a total of eight or nine, this is commonly known as a “natural.” In this case, the player will receive no more cards. The banker must also either tie the player hand or win by one and no further cards will be drawn. The highest natural is the automatic winner. The player also receives no more cards if the total points equal six or seven. Any other combination that equals zero through five a third card will be drawn, unless the banker has drawn a natural resulting in a win that will be awarded to the banker. Table 1 is provided as follows:

TABLE 1

| First two cards total: | Action |
|---|---|
| 0, 1, 2, 3, 4, 5 | Draws a card |
| 6, 7 | Stands |
| 8, 9 | Natural - Neither hand draws |

The banker will stand on seven, eight, or nine. The banker will also draw on zero, one, or two. For all other hands, the banker's play is contingent on the value of the player's third card. The banker hits on three unless the player's third card is an eight; hits on four unless the player's third card is one, eight, nine, or ten; hits on five only if the player's third card is four, five, six, or seven; and hits on six only if the player's third card is six or seven. Table 2 is provided as follows:

TABLE 2

| First two | Draws when player's | Stands when player's |
|---|---|---|
| cards total: | third card is: | third card is: |
| 3 | 1, 2, 3, 4, 5, 6, 7, 9, 10 | 8 |
| 4 | 2, 3, 4, 5, 6, 7 | 1, 8, 9, 10 |
| 5 | 4, 5, 6, 7 | 1, 2, 3, 8, 9, 10 |
| 6 | 6, 7 | 1, 2, 3, 4, 5, 8, 9, 10 |
| 7 | Stands | |
| 8, 0 | Natural - Stands | |
| 0, 1, 2 | Always draws | |

A few exceptions are as follows: a natural stops all play and the player has one of its other two standing hands, six or seven. The banker will also stand on six as well as seven, eight, and nine. Neither hand ever gets more than three cards maximum. After the hands are played out, the hand totaling closest to nine wins the round. If there is a tie, neither hand wins nor loses and money is returned to the user.

If the user selects the correct outcome, then they are paid accordingly. If the user wins on a player hand, it is paid out at 1-1 (2×). If the user wins on the banker hand, it is paid out at 0.85-1 (1.85×). If the user wins on a tie, the payoff is at 11-1 (12×).

With reference to FIG. 3, interface 300 depicts that hands of baccarat are randomly-generated and dealt (e.g., based on the above-described rules) at 8 different tables, with each table corresponding to a separate shoe (e.g., a six-deck shoe) of playing cards. Player wins, bank wins and ties are presented to the user. In this example, the tables are labeled from 1-9 excluding 4. Player wins represented by “P” are shown for tables (e.g., baccarat hands) 1, 2, 5, 6 and 8, banker wins represented by “B” are shown for tables 3 and 6, and a tie represented by “T” is shown for table 9. Based on the bets placed in the example of FIG. 2, the user is awarded wins for tables 1 and 3 (e.g., as represented by the “Winner” indication in FIG. 3), and payouts are provided accordingly in conjunction with payout component 108.

FIG. 4 illustrates an example graphical user interface with a hand history for baccarat. As noted above, road data from the big eye, small, and cockroach trends or roads can be stored and maintained. These roads are generated from data corresponding to the big road. Each of these roads can be accessed and/or stored in memory as one or more data structures (e.g., in association with history analysis component 110), and can further be updated in real time (e.g., where the outcome of a current hand is used to update the roads).

The accessed roadmap data can be displayed to the user, for example, in association with display component 106. The graphical representations of the roads correspond to results of the previous games of baccarat (e.g., for each respective table). The roads can help the players quickly and easily analyze the history of the game, look for trends, and possibly predict the results in the future.

Display component 106 can provide for representations of road data on a main screen, or on one or more secondary screens associated with apparatus 100. In the example of FIG. 4, hand history is depicted for each of tables 1 through 8, to provide the user with information regarding outcomes for prior hands played at each of the respective tables. With respect to each of tables 1 through 8, the hand history information can include, but is not limited, to game statistics 402 (e.g., current game credits, wins), bead road 404, probing data 406 (described below with reference to FIG. 13), big road 408, big eye road 410, small road 412 and cockroach road 414.

In example aspects, all types of roads are represented by using icons arranged in a rectangular grid of empty squares. The height of any road may always be set at 6, and the width of any road is not fixed, but may be at least 12. In example aspects, the road only records the history for the current shoe (e.g., of eight decks). Once a new shoe is to be used, the road is cleared.

As noted above, there are 5 types of roads, as follows:

1. [symbol] (bead road)

2. [symbol] (big road)

3. [symbol] (big eye road)

4. [symbol] (small road)

5. [symbol] (cockroach road)

The size of the icons of the first type of road is usually the largest, while the size of the icons of the last 3 types of roads (big eye, small, cockroach) is usually the smallest.

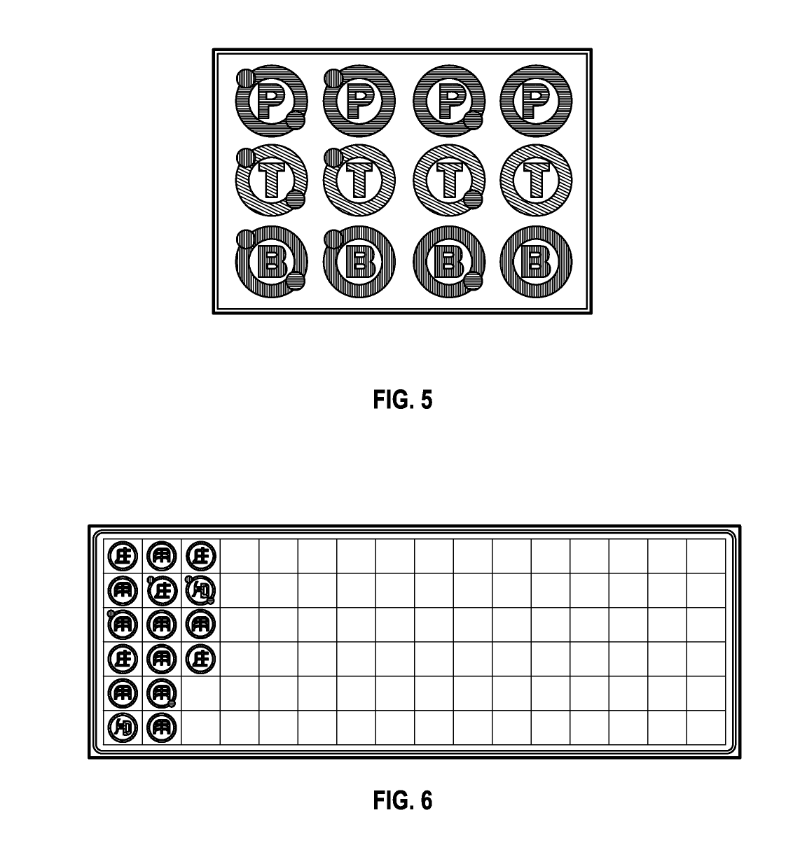

FIG. 5 illustrates an example of the different icons that may appear within a bead road for baccarat hands. This road simply shows the results (banker wins represented by a “B” icon, player wins represented by a “P” icon, and ties represented a by “T” icon) of the previous rounds, with the icons arranged in a rectangular grid in a top-to-bottom, left-to-right fashion. Each icon corresponds to one previous round. That is, the icon for the first round is put on the top left corner, which for the second round is on the one below it, and so on.

In the example of FIG. 5, each icon is a simple circle, usually with the name (or abbreviation “B”, “P” or “T”) written in the middle in a specific language (e.g., English, Chinese). Banker wins may be depicted in a first color (e.g., red) or pattern, player wins in a second color (e.g., blue) or pattern, and ties in a third color (e.g., green) or pattern.

Pairs can also be shown on the icons. Banker pairs are shown as a dot of a first color (e.g., red) or pattern placed on the top left corner of the icon. Player pairs are shown as a dot of a second color (e.g., blue) or pattern placed on the lower right corner of the icon.

FIG. 6 illustrates an example of a bead road for baccarat hands. A sample [symbol] bead road with 16 rounds is illustrated in FIG. 6, where the icons are in simplified Chinese for this example.

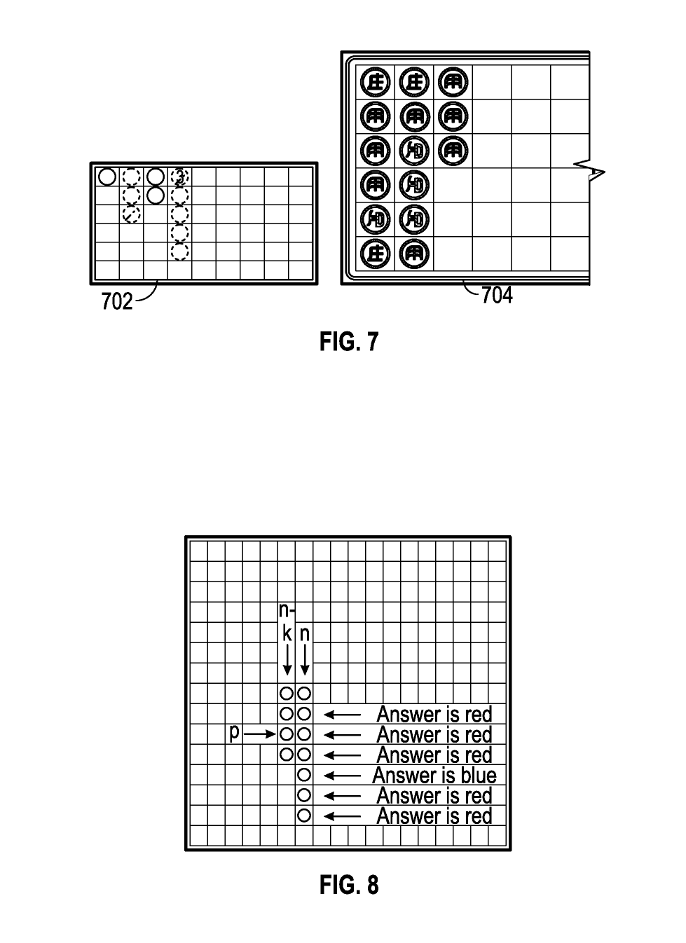

FIG. 7 illustrates an example of a big road and a corresponding bead road for baccarat hands. The big road (e.g., element 702) arranges the results in columns, or streaks, to allow for easier counting of consecutive wins and studying of trends.

The icons in the big road are shown as hollow circles. Bankers are in a first color (e.g., red) or pattern, and players are in a second color (e.g., blue) or pattern. Pairs (banker pairs, player pairs) are not shown in the big road at all.

Further, ties are not shown as a separate icon. Instead, they are shown as a stripe of a third color (e.g., green) or pattern, embedded inside the circle of the last round. If there is more than one consecutive tie, the number of ties will be written on the stripe (e.g., in green).

In case the first round of the shoe is a tie, its icon will be a simple stripe of the third color (e.g., green) or pattern with no circles surrounding it. Again, if there is more than one consecutive tie at the beginning of the shoe, the number of ties will be presented as well. Table 3, an example of icons in the [symbol] big road, is provided as follows:

TABLE 3

| Icon | Description |
|---|---|
| [symbol] | Banker. |
| [symbol] | Player. |
| [symbol] | Banker, followed by a Tie. |
| [symbol] | Banker, followed by 2 Ties. |
| [symbol] | Tie in the 1^{st} round of the shoe. |
| [symbol] | 2 Ties at the beginning of the shoe. |

If the first round of the shoe is a tie and the second round is a banker, the circle for banker will be drawn in the same square as that of the stripe (e.g., third color or pattern) for tie. In other words, a tie-banker combination and a banker-tie combination at the beginning of a shoe is undistinguishable in this road.

The icons are arranged such that the banker and player icons are arranged on separate columns, or streaks. Each time the result flips between banker and player, a new column is used. In the example of FIG. 7, the [symbol] big road 702 and its corresponding [symbol] bead road 704 are provided.

A description of the big eye road ( [symbol] ), small road ( [symbol] ) and cockroach road ( [symbol] [symbol] ) will now be provided. These three types of roads are similar, with the only differences among the three types being the Cycle, as described below, and the icons used. Table 4, a summary of the three types of roads, is provided below as follows:

TABLE 4

| Type of Roadmap | Icons | Cycle |
|---|---|---|
| [symbol] (Big Eye Road) | [symbol] and [symbol] | 1 |
| [symbol] (Small Road) | [symbol] and [symbol] | 2 |
| [symbol] (Cockroach Road) | [symbol] and [symbol] | 3 |

In example aspects, the three types of roads are not a direct representation of the history of the game. Instead, they are all derived from the [symbol] (big road). Every time a banker or player icon is added to the [symbol] (big road), a derived icon is added to these three roads based on the rules described below.

It should be noted that even though the icons in these three derived roads can be presented in different colors/patterns (e.g., red and blue), there is no relationship between their colors and the colors of banker and player.

A new icon to any of the 3 derived roads can be added after a round, based on the following rules:
1. Let k be the Cycle of the road.
2. Assume that the last icon added to the [symbol] (Big Road) is on row m of column n.
   a. If m>=2, compare with column (n-k).
      i. If there is no such column (i.e. before the first column) . . . No need to add any icon.
      ii. If there is such a column, and the column has p icons.
         1. If m<=p . . . The answer is red.
         2. If m=p+1 . . . The answer is blue.
         3. If m>p+1 . . . The answer is red.
      b. If m=1, reverse the result (Banker to Player, and vice versa), determine the result as in rule 2.a above, and reverse the answer (Red to blue, and vice versa) to get the real answer.

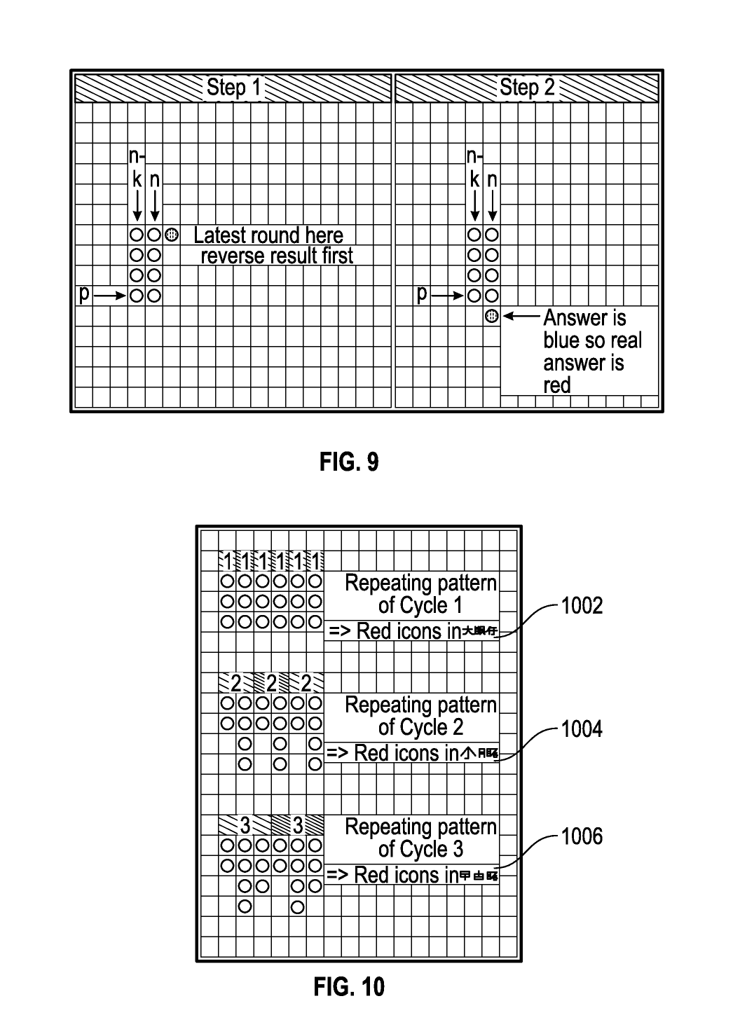

In example aspects, it should be noted that it does not matter whether the icons in the [symbol] (big road) are banker or player, and only the number of icons on each column is important. FIGS. 8 and 9 illustrate different examples of the foregoing rules.

FIG. 8 illustrates an example of a big road for baccarat hands. In the example of FIG. 8, the foregoing rules when m>=2 is illustrated. The black dots represent the icons in the [symbol] (big Road).

FIG. 9 illustrates another example of a big road for baccarat hands. In the example of FIG. 9, the foregoing rules when m=1 is illustrated. The black dots represent the icons in the [symbol] [symbol] (big Road).

In example aspects, the idea behind the big eye road ( [symbol] ), small road ( [symbol] ) and cockroach road ( [symbol] ) is that, when there are many consecutive bankers or players, all three of them will appear in a first color (e.g., red) or pattern. When there is a repeating pattern of cycle k, the corresponding road will also appear in the first color or pattern. In short, the appearance of icons in the first color or pattern in these roads can mean that the [symbol] (big road) is somewhat consistent. Such consistency can be used in determining a predicted outcome (e.g., best guess) as described above, for example.

FIG. 10 conceptually illustrates a relation between a big eye road, a small road and a cockroach road for baccarat hands. In the example of FIG. 10, the black dots represent the icons in the [symbol] (big road). In addition, icons of the first color (e.g., red) or pattern are shown for each of the big eye road 1002, small road 1004 and cockroach road 1006.

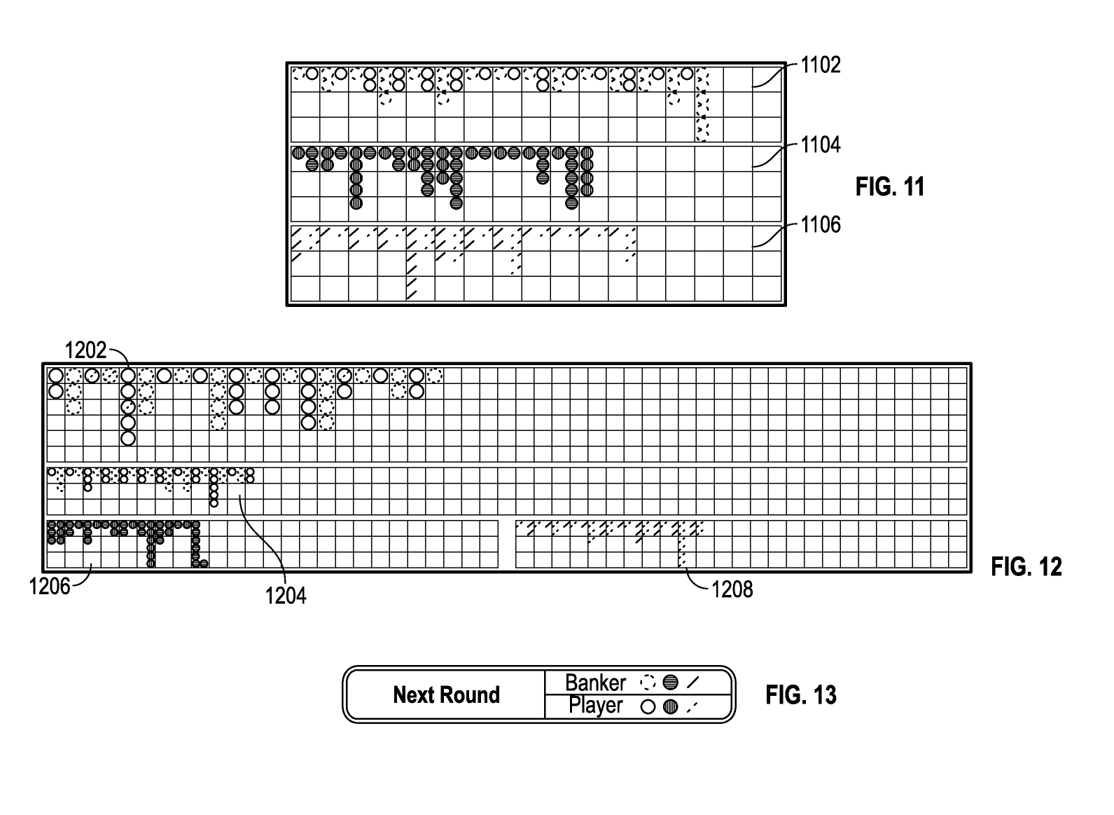

FIG. 11 illustrates an example for a big eye road, a small road and a cockroach road for baccarat hands. FIG. 11 illustrates an example of the 3 roads of the [symbol] (big eye road 1102), [symbol] (small road 1104), and [symbol] (cockroach road 1006).

Although there is no restriction as for where to put the roads on the screen, four roads, [symbol] , [symbol] , [symbol] , and [symbol] , are usually aligned in a specific way, as shown in Table 5. Table 5, a typical layout of the roads, is as follows:

TABLE 5 [symbol]
(Big Road) [symbol]
(Big Eye Road)

| | |
|---|---|
| [symbol] (Small Road) | [symbol] (Cockroach Road) |

FIG. 12 illustrates another example for a big eye road, a small road and a cockroach road for baccarat hands. FIG. 12 can correspond to a real-life example of the layout of the four roads. They are [symbol] (big road 1202), [symbol] (big eye road 1204), [symbol] (small road 1206), and [symbol] ((cockroach road 1208). In example aspects, there is no restriction on where the [symbol] [symbol] (bead road) should be presented.

FIG. 13 illustrates an example of road probing for a next round of baccarat. As noted above with reference to FIG. 4, probing data 406 can be presented as history information for each of multiple tables of baccarat. In example aspects, road probing is a way to further help the players analyze the roads. It shows what next icon will be added to the three derived roads if the next round is banker or player.

As shown in FIG. 13, the road probing shows what next icon will be added to the three derived roads. If no icon will be added to a derived road, its corresponding icon will also be missing from the probe results. It should be noted that the probe results for banker and player can always be in different colors or patterns.

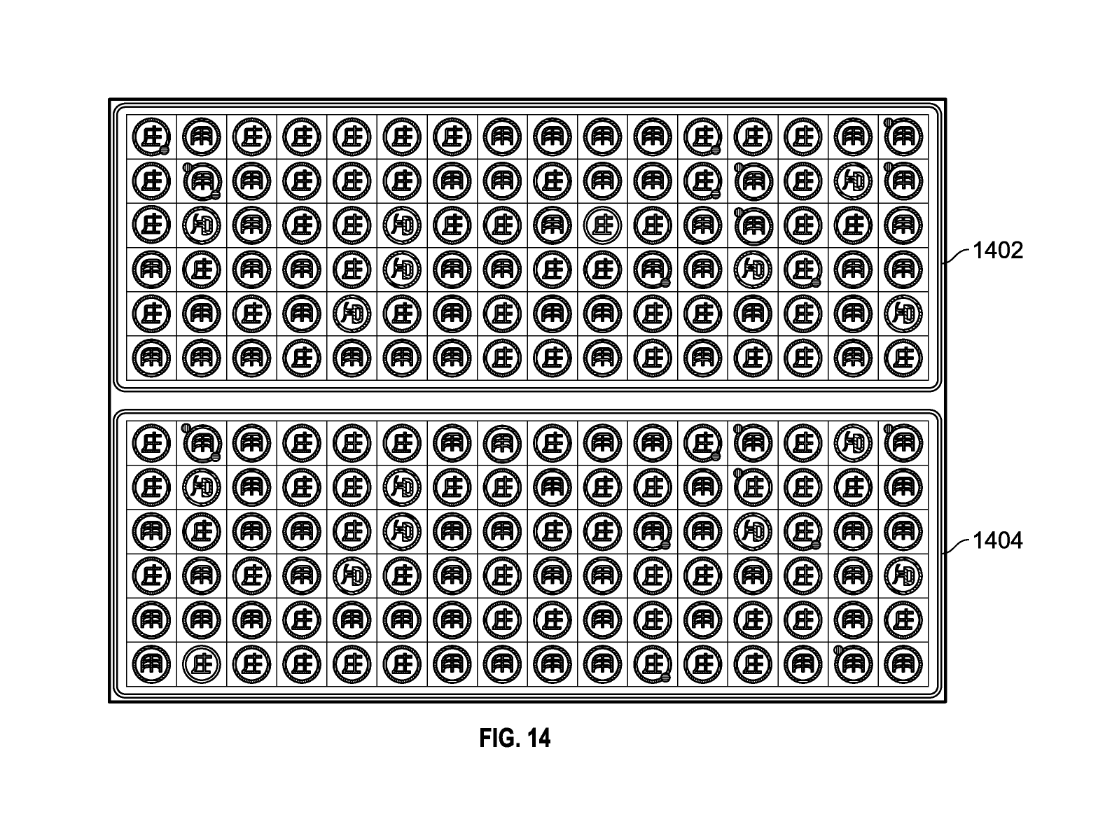

FIG. 14 illustrates an example of a bead road for baccarat hands where the bead road becomes full. Since the dimension of a road is fixed, sometimes, it is possible that the road runs out of room. For the [symbol] (bead road), when it runs out of room, the icon for the oldest round is removed. When the road is full, the oldest icon is removed to make room for the new one. In the example of FIG. 14, an old road 1402 and new road 1404 illustrate removal of icon for the oldest round.

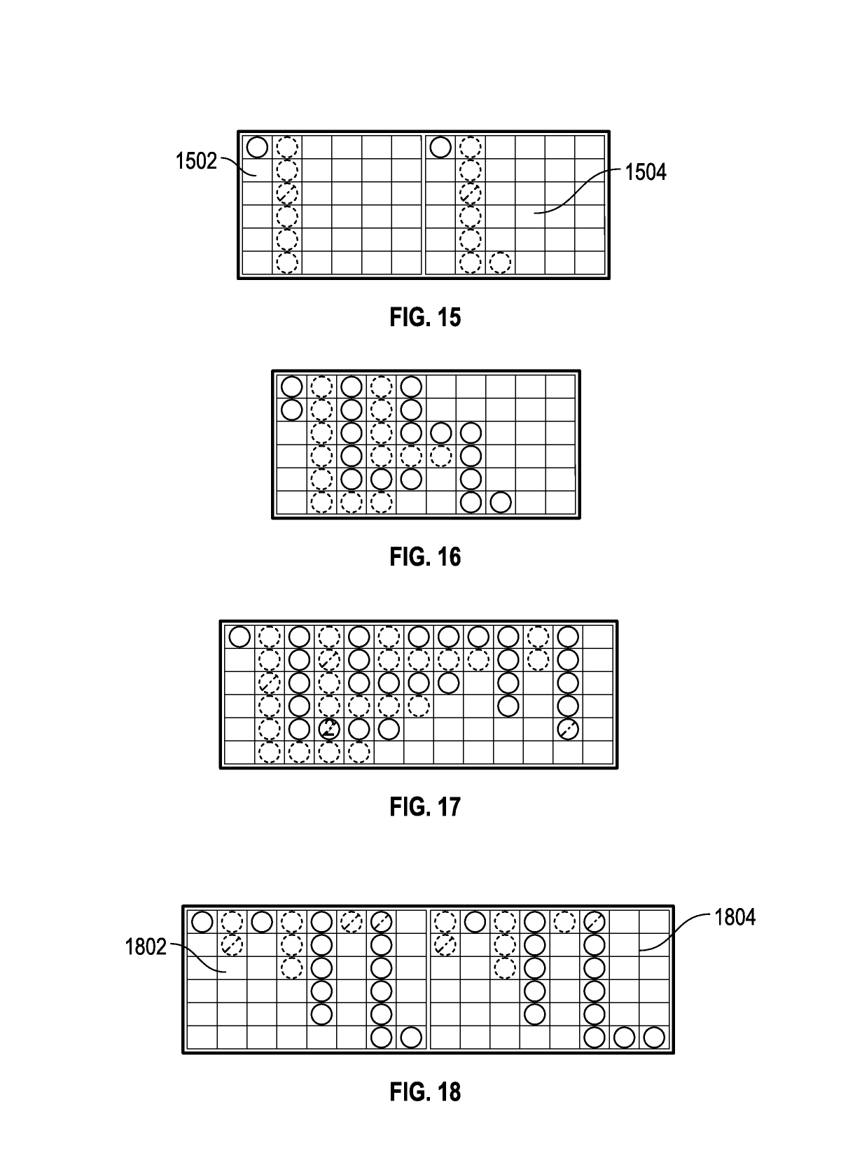

FIG. 15 illustrates an example of a road in which a column turns right after having more than 6 icons. When there are more than six icons for one column, the column turns right. In the example of FIG. 15, an old road 1502 and new road 1504 illustrate the column turning right.

FIG. 16 illustrates another example of a road in which a column turns right. In this regard, it is possible that the space is occupied when a column goes down. In that case, the column turns right until there is room to go down again. The column turns right whenever it cannot go down.

FIG. 17 illustrates another example of a road in which a column turns right. In the case (e.g., which is rare) that there is no space for a column to go down at the very first square, the column turns right immediately, occupying the starting square of the next column. When the next column starts, it will use the next empty column. In other words, the column turns right immediately if it is occupied below. The next column is placed at the next empty column

FIG. 18 illustrates an example of a road in which the whole road shifts left by a column. After many rounds are dealt in a shoe, it might also be possible that there is no more space on the right. In that case, all icons in the road shift left by one column, abandoning those on the original left most column, and making room for a new column on the right. In other words, when there is no more room on the right, the whole road shifts left by a column. In the example of FIG. 18, an old road 1802 and a new road 1804 illustrated such a shift.

It should be noted that all these behaviors described with reference to FIGS. 15-18 do not affect how the three derived roads are formed. The derivation rules are used as if there are no size limitations to all the roads.

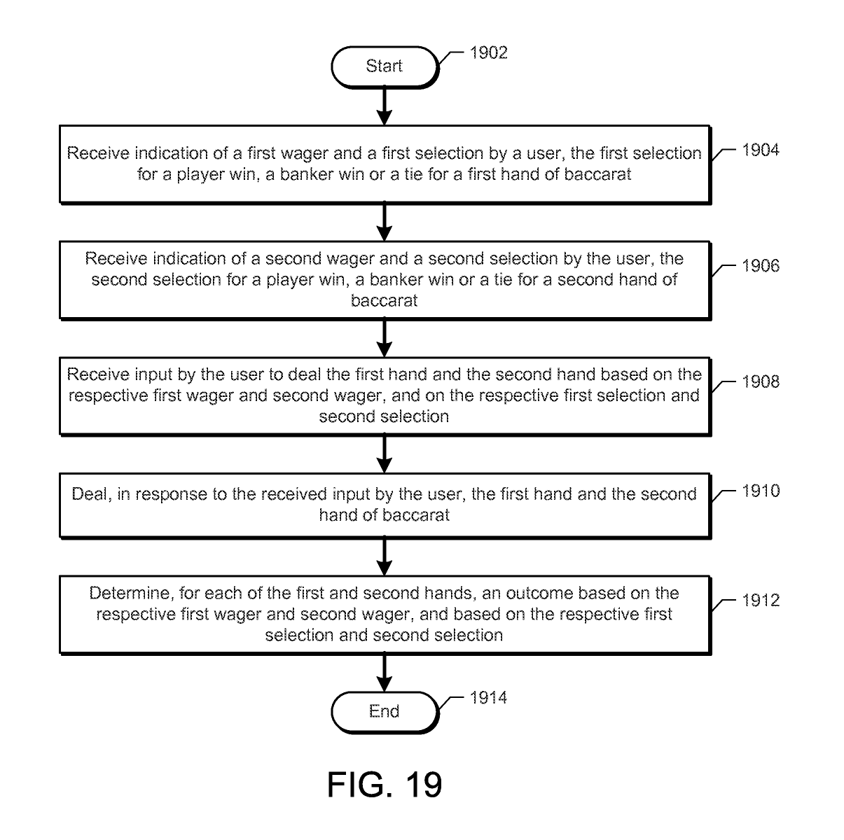

FIG. 19 illustrates an example process by which baccarat is played. Following start block 1902, indication of a first wager and a first selection by a user is received at block 1904. The first selection is for a player win, a banker win or a tie for a first hand of baccarat.

At block 1906, indication of a second wager and a second selection by the user is received. The second selection is for a player win, a banker win or a tie for a second hand of baccarat. At block 1908, input by the user is received, to deal the first hand and the second hand based on the respective first wager and second wager, and on the respective first selection and second selection. At block 1910, in response to the received input by the user, the first hand and the second hand of baccarat are dealt. At block 1912, for each of the first and second hands, an outcome is determined based on the respective first wager and second wager, and based on the respective first selection and second selection.

Indication of one or more additional wagers and one or more additional selections by the user can be received, the one or more additional selections respectively for a player win, a banker win or a tie for each of one or more additional hands of baccarat. The received input by the user can further be for dealing the one or more additional hands based on the respective one or more additional wagers, and on the respective one or more additional selections. The dealing can further comprise dealing the one or more additional hands of baccarat, and the determining can further comprise determining, for each of the one or more additional hands, an outcome based on the respective one or more additional wagers, and based on the respective one or more additional selections.

For each of the first hand, the second hand and the one or more additional hands, a separate instance of a random number generator can be used to deal the hand. For each of the first hand, the second hand and the one or more additional hands, payout can be provided for the hand based on the respective outcome for the hand. The process then ends at end block 1914.

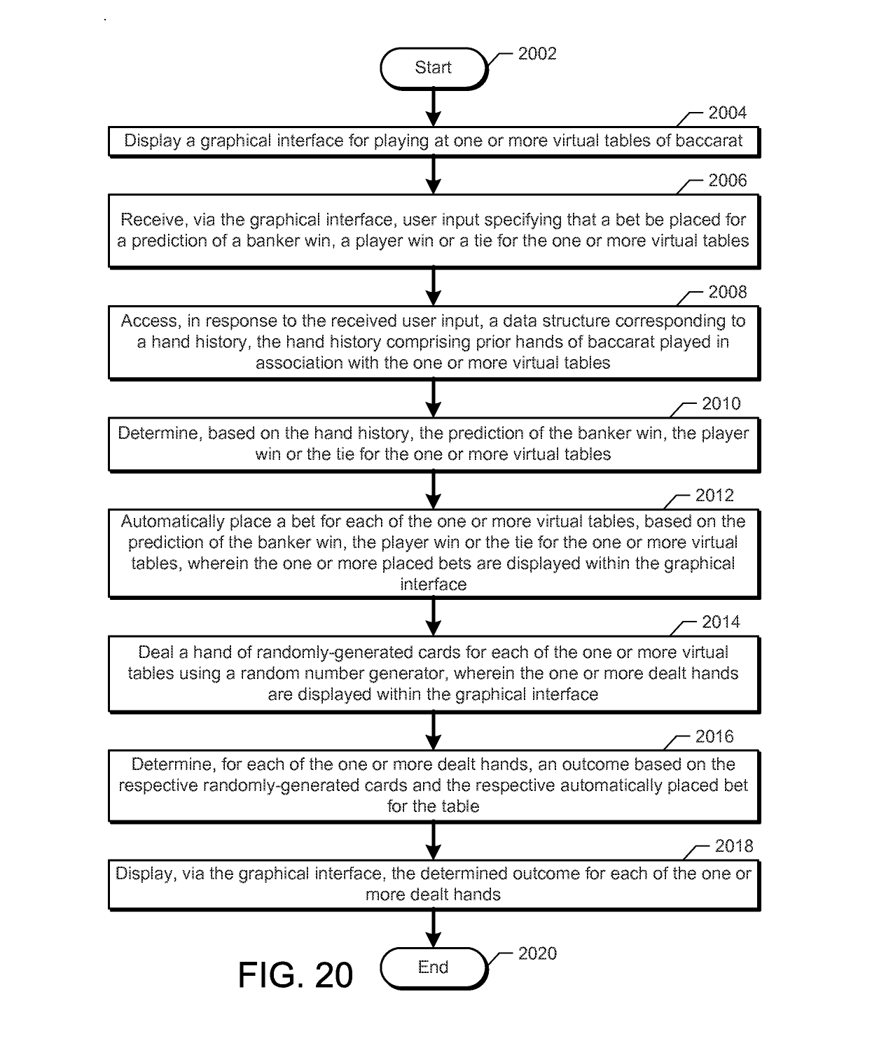

FIG. 20 illustrates another example process by which baccarat is played. Following start block 2002, a graphical interface for playing at one or more virtual tables of baccarat is displayed at block 2004.

The graphical interface can provide for a user to select the one or more virtual tables of baccarat from among multiple virtual tables of baccarat available for play, and user selection of the one or more virtual tables from among the multiple virtual tables can be received via the graphical interface. For example, the multiple virtual tables of baccarat available for play is 8, and the one or more virtual tables corresponds to 8 or less virtual tables based on the user selection.

At block 2006, user input is received via the graphical interface, the user input specifying that a bet be placed for a prediction of a banker win, a player win or a tie for the one or more virtual tables.

At block 2008, a data structure corresponding to a hand history is accessed in response to the received user input, the hand history comprising prior hands of baccarat played in association with the one or more virtual tables.

At block 2010, the prediction of the banker win, the player win or the tie is determined for the one or more virtual tables, based on the hand history. The data structure can correspond to trending road data for the hand history, and the prediction can be based on the trending road data. The trending road data can comprise big road data. The trending road data can further comprise at least one of big eye road data, small road data or cockroach road data, each of which represent a respective level of consistency of outcomes from the big road data.

Determining the prediction of the banker win, the player win or the tie for the one or more virtual tables can be based on the respective level of consistency of outcomes represented by the at least one of the big eye road data, the small road data or the cockroach road data.

At block 2012, a bet is automatically placed for each of the one or more virtual tables, based on the prediction of the banker win, the player win or the tie for the one or more virtual tables. The one or more placed bets are displayed within the graphical interface.

At block 2014, a hand of randomly-generated cards is dealt for each of the one or more virtual tables using a random number generator. The one or more dealt hands are displayed within the graphical interface. For each of the one or more virtual tables, a separate instance of a random number generator can be used to deal the hand of randomly-generated cards for the virtual table.

At block 2016, an outcome for each of the one or more dealt hands is determined, based on the respective randomly-generated cards and the respective automatically placed bet for the table.

At block 2018, the determined outcome for each of the one or more dealt hands is displayed via the graphical interface. For each of the one or more virtual tables, payout can be provided based on the respective outcome for the dealt hand and the automatically placed bet for the virtual table. The data structure can be updated based on the determined outcome for each of the one or more virtual tables. The process ends at end block 2020.

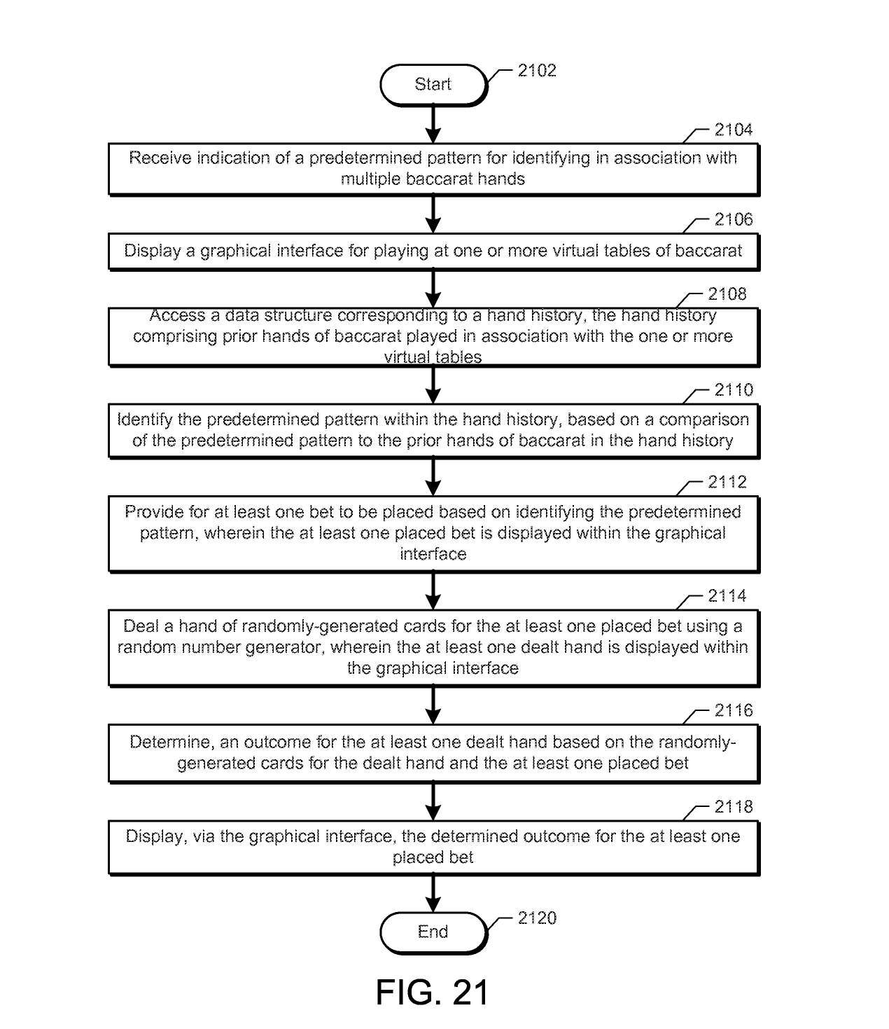

FIG. 21 illustrates yet another example process by which baccarat is played. Following start block 2102, indication of a predetermined pattern for identifying in association with multiple baccarat hands is received at block 2104.

At block 2106, a graphical interface for playing at one or more virtual tables of baccarat is displayed. The graphical interface can provide for a user to select the one or more virtual tables of baccarat from among multiple virtual tables of baccarat available for play, and user selection of the one or more virtual tables from among the multiple virtual tables can be received via the graphical interface. For example, the multiple virtual tables of baccarat available for play is 8, and the one or more virtual tables corresponds to 8 or less virtual tables based on the user selection.

A second graphical interface can provide for a user to select the predetermined pattern from among multiple predetermined patterns for identifying in association with the multiple baccarat hands.

At block 2108, a data structure corresponding to a hand history is accessed, the hand history comprising prior hands of baccarat played in association with the one or more virtual tables.

At block 2110, the predetermined pattern is identified within the hand history, based on a comparison of the predetermined pattern to the prior hands of baccarat in the hand history.

Prior to identifying the predetermined pattern within the hand history, a determination can be made that the predetermined pattern is within a threshold level of occurring within the hand history, based on a comparison of the predetermined pattern to the prior hands of baccarat in the hand history. A user notification of the determination that the predetermined pattern is within the threshold level of occurring can be provided to the user via the graphical interface.

At block 2112, at least one bet is placed based on identifying the predetermined pattern. The at least one placed bet is displayed within the graphical interface.

Providing for the at least one bet to be placed can comprise prompting, via the graphical interface, for a user to place the at least one bet, receiving, via the graphical interface and in response to the prompting, user input to place the at least one bet, and placing, in response to the received user input, the at least one bet, where the at least one bet is displayed within the graphical interface.

Alternatively, providing for the at least one bet to be placed can comprise automatically placing the at least one bet based on identifying the predetermined pattern, where the at least one bet is displayed within the graphical interface.

At block 2114, a hand of randomly-generated cards is dealt for the at least one placed bet using a random number generator. The at least one dealt hand is displayed within the graphical interface. For each of the one or more virtual tables, a separate instance of a random number generator can be used to deal the hand of randomly-generated cards for the virtual table.

At block 2116, an outcome is determined for the at least one dealt hand based on the randomly-generated cards for the dealt hand and the at least one placed bet.

At block 2118, the determined outcome for the at least one placed bet is displayed via the graphical interface. For each of the one or more virtual tables, payout can be provided based on the determined outcome and the at least one placed bet. The data structure can be updated based on the determined outcome for the at least one dealt hand. The process ends at end block 2120.

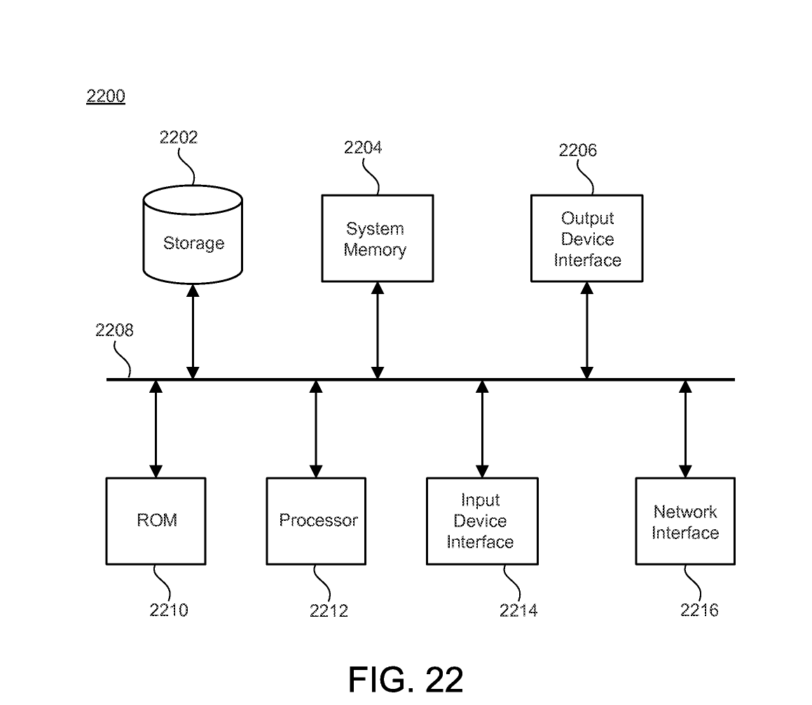

FIG. 22 conceptually illustrates an example electronic system with which some implementations of the subject technology can be implemented. Electronic system 2200 can be a server, computer, phone, PDA, laptop, tablet computer, television with one or more processors embedded therein or coupled thereto, or any other sort of electronic device. Electronic system 2200 may be representative of a client device, server, and/or processor. Such an electronic system includes various types of computer readable media and interfaces for various other types of computer readable media. Electronic system 2200 includes a bus 2208, processing unit(s) 2212, a system memory 2204, a read-only memory (ROM) 2210, a permanent storage device 2202, an input device interface 2214, an output device interface 2206, and a network interface 2216.

Bus 2208 collectively represents all system, peripheral, and chipset buses that communicatively connect the numerous internal devices of electronic system 2200. For instance, bus 2208 communicatively connects processing unit(s) 2212 with ROM 2210, system memory 2204, and permanent storage device 2202.

From these various memory units, processing unit(s) 2212 retrieves instructions to execute and data to process in order to execute the processes of the subject disclosure. The processing unit(s) can be a single processor or a multi-core processor in different implementations.

ROM 2210 stores static data and instructions that are needed by processing unit(s) 2212 and other modules of the electronic system. Permanent storage device 2202, on the other hand, is a read-and-write memory device. This device is a non-volatile memory unit that stores instructions and data even when electronic system 2200 is off. Some implementations of the subject disclosure use a mass-storage device (such as a magnetic or optical disk and its corresponding disk drive) as permanent storage device 2202.

Other implementations use a removable storage device (such as a floppy disk, flash drive, and its corresponding disk drive) as permanent storage device 2202. Like permanent storage device 2202, system memory 2204 is a read-and-write memory device. However, unlike storage device 2202, system memory 2204 is a volatile read-and-write memory, such a random access memory. System memory 2204 stores some of the instructions and data that the processor needs at runtime. In some implementations, the processes of the subject disclosure are stored in system memory 2204, permanent storage device 2202, and/or ROM 2210. For example, the various memory units include instructions for facilitating remote betting in live games according to various implementations. From these various memory units, processing unit(s) 2212 retrieves instructions to execute and data to process in order to execute the processes of some implementations.

Bus 2208 also connects to input and output device interfaces 2214 and 2206. Input device interface 2214 enables the user to communicate information and select commands to the electronic system. Input devices used with input device interface 2214 include, for example, alphanumeric keyboards and pointing devices (also called “cursor control devices”). Output device interfaces 2206 enables, for example, the display of images generated by the electronic system 2200. Output devices used with output device interface 2206 include, for example, printers and display devices, such as cathode ray tubes (CRT) or liquid crystal displays (LCD). Some implementations include devices such as a touchscreen that functions as both input and output devices.

Finally, as shown in FIG. 22, bus 2208 also couples electronic system 2200 to a network (not shown) through a network interface 2216. In this manner, the computer can be a part of a network of computers (such as a local area network (“LAN”), a wide area network (“WAN”), or an Intranet, or a network of networks, such as the Internet. Any or all components of electronic system 2200 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A method for playing multiple hands of baccarat, comprising:
receiving indication of a first wager and a first selection by a user, the first selection for a player win, a banker win or a tie for a first hand of baccarat;
receiving indication of a second wager and a second selection by the user, the second selection for a player win, a banker win or a tie for a second hand of baccarat;
receiving input by the user to deal the first hand and the second hand based on the respective first wager and second wager, and on the respective first selection and second selection;
dealing, in response to the received input by the user, the first hand and the second hand of baccarat; and
determining, for each of the first and second hands, an outcome based on the respective first wager and second wager, and based on the respective first selection and second selection.

2. The method of claim 1, further comprising:
receiving indication of one or more additional wagers and one or more additional selections by the user, the one or more additional selections respectively for a player win, a banker win or a tie for each of one or more additional hands of baccarat,
wherein the received input by the user is further to deal the one or more additional hands based on the respective one or more additional wagers, and on the respective one or more additional selections,
wherein the dealing further comprises dealing the one or more additional hands of baccarat, and
wherein the determining further comprises determining, for each of the one or more additional hands, an outcome based on the respective one or more additional wagers, and based on the respective one or more additional selections.

3. The method of claim 2, wherein for each of the first hand, the second hand and the one or more additional hands, a separate instance of a random number generator is used to deal the hand.

4. The method of claim 2, further comprising, for each of the first hand, the second hand and the one or more additional hands, providing payout for the hand based on the respective outcome for the hand.

5. A system for playing multiple hands of baccarat, comprising:
one or more processors; and
a machine-readable medium comprising instructions stored therein, which when executed by the processors, cause the processors to perform operations comprising:
receiving indication of a first wager and a first selection by a user, the first selection for a player win, a banker win or a tie for a first hand of baccarat;
receiving indication of a second wager and a second selection by the user, the second selection for a player win, a banker win or a tie for a second hand of baccarat;
receiving input by the user to deal the first hand and the second hand based on the respective first wager and second wager, and on the respective first selection and second selection;
dealing, in response to the received input by the user, the first hand and the second hand of baccarat; and
determining, for each of the first and second hands, an outcome based on the respective first wager and second wager, and based on the respective first selection and second selection.

6. The system of claim 5, the operations further comprising:
receiving indication of one or more additional wagers and one or more additional selections by the user, the one or more additional selections respectively for a player win, a banker win or a tie for each of one or more additional hands of baccarat,
wherein the received input by the user is further to deal the one or more additional hands based on the respective one or more additional wagers, and on the respective one or more additional selections,
wherein the dealing further comprises dealing the one or more additional hands of baccarat, and
wherein the determining further comprises determining, for each of the one or more additional hands, an outcome based on the respective one or more additional wagers, and based on the respective one or more additional selections.

7. The system of claim 6, wherein for each of the first hand, the second hand and the one or more additional hands, a separate instance of a random number generator is used to deal the hand.

8. The system of claim 6, the operations further comprising, for each of the first hand, the second hand and the one or more additional hands, providing payout for the hand based on the respective outcome for the hand.

9. A system for playing baccarat, the system comprising:
one or more processors; and
a machine-readable medium comprising instructions stored therein, which when executed by the processors, cause the processors to perform operations comprising:
displaying a graphical interface for playing at one or more virtual tables of baccarat;
receiving, via the graphical interface, user input specifying that a bet be placed for a prediction of a banker win, a player win or a tie for the one or more virtual tables;
accessing, in response to the received user input, a data structure corresponding to a hand history, the hand history comprising prior hands of baccarat played in association with the one or more virtual tables;
determining, based on the hand history, the prediction of the banker win, the player win or the tie for the one or more virtual tables;
automatically placing a bet for each of the one or more virtual tables, based on the prediction of the banker win, the player win or the tie for the one or more virtual tables, wherein the one or more placed bets are displayed within the graphical interface;
dealing a hand of randomly-generated cards for each of the one or more virtual tables using a random number generator, wherein the one or more dealt hands are displayed within the graphical interface;
determining, for each of the one or more dealt hands, an outcome based on the respective randomly-generated cards and the respective automatically placed bet for the table; and
displaying, via the graphical interface, the determined outcome for each of the one or more dealt hands.

10. The system of claim 9, the operations further comprising:
providing, via the graphical interface, for a user to select the one or more virtual tables of baccarat from among multiple virtual tables of baccarat available for play; and
receiving, via the graphical interface, user selection of the one or more virtual tables from among the multiple virtual tables.

11. The system of claim 10, wherein the multiple virtual tables of baccarat available for play is 8, and wherein the one or more virtual tables corresponds to 8 or less virtual tables based on the user selection.

12. The system of claim 9, wherein for each of the one or more virtual tables, a separate instance of a random number generator is used to deal the hand of randomly-generated cards for the virtual table.

13. The system of claim 9, wherein the data structure corresponds to trending road data for the hand history, and wherein the prediction is based on the trending road data.

14. The system of claim 13, wherein the trending road data comprises big road data, and wherein the trending road data further comprises at least one of big eye road data, small road data or cockroach road data, each of which represent a respective level of consistency of outcomes from the big road data.

15. The system of claim 14, wherein determining the prediction of the banker win, the player win or the tie for the one or more virtual tables is based on the respective level of consistency of outcomes represented by the at least one of the big eye road data, the small road data or the cockroach road data.

16. The method of claim 9, further comprising:
providing payout, for each of the one or more virtual tables, based on the respective outcome for the dealt hand and the automatically placed bet for the virtual table.

17. The system of claim 9, the operations further comprising:
updating the data structure based on the determined outcome for each of the one or more virtual tables.

18. A method for playing baccarat, the method comprising:
displaying a graphical interface for playing at one or more virtual tables of baccarat;
receiving, via the graphical interface, user input specifying that a bet be placed for a prediction of a banker win, a player win or a tie for the one or more virtual tables;
accessing, in response to the received user input, a data structure corresponding to a hand history, the hand history comprising prior hands of baccarat played in association with the one or more virtual tables;
determining, based on the hand history, the prediction of the banker win, the player win or the tie for the one or more virtual tables;
automatically placing a bet for each of the one or more virtual tables, based on the prediction of the banker win, the player win or the tie for the one or more virtual tables, wherein the one or more placed bets are displayed within the graphical interface;
dealing a hand of randomly-generated cards for each of the one or more virtual tables using a random number generator, wherein the one or more dealt hands are displayed within the graphical interface;
determining, for each of the one or more dealt hands, an outcome based on the respective randomly-generated cards and the respective automatically placed bet for the table; and
displaying, via the graphical interface, the determined outcome for each of the one or more dealt hands.

19. A system for playing baccarat, the system comprising:
one or more processors; and
a machine-readable medium comprising instructions stored therein, which when executed by the processors, cause the processors to perform operations comprising:
receiving indication of a predetermined pattern for identifying in association with multiple baccarat hands;
displaying a graphical interface for playing at one or more virtual tables of baccarat;
accessing a data structure corresponding to a hand history, the hand history comprising prior hands of baccarat played in association with the one or more virtual tables;
identifying the predetermined pattern within the hand history, based on a comparison of the predetermined pattern to the prior hands of baccarat in the hand history;
providing for at least one bet to be placed based on identifying the predetermined pattern, wherein the at least one placed bet is displayed within the graphical interface;
dealing a hand of randomly-generated cards for the at least one placed bet using a random number generator, wherein the at least one dealt hand is displayed within the graphical interface;
determining, an outcome for the at least one dealt hand based on the randomly-generated cards for the dealt hand and the at least one placed bet; and
displaying, via the graphical interface, the determined outcome for the at least one placed bet.

20. The system of claim 19, the operations further comprising:
providing, via the graphical interface, for a user to select the one or more virtual tables of baccarat from among multiple virtual tables of baccarat available for play; and
receiving, via the graphical interface, user selection of the one or more virtual tables from among the multiple virtual tables.

21. The system of claim 20, wherein the multiple virtual tables of baccarat available for play is 8, and wherein the one or more virtual tables corresponds to 8 or less virtual tables based on the user selection.

22. The system of claim 19, wherein for each of the one or more virtual tables, a separate instance of a random number generator is used to deal the hand of randomly-generated cards for the virtual table.

23. The system of claim 19, the operations further comprising:
providing, via a second graphical interface, for a user to select the predetermined pattern from among multiple predetermined patterns for identifying in association with the multiple baccarat hands.

24. The system of claim 23, the operations further comprising:
updating the data structure based on the determined outcome for the at least one dealt hand.

25. The system of claim 19, wherein providing for the at least one bet to be placed comprises:
prompting, via the graphical interface, for a user to place the at least one bet;
receiving, via the graphical interface and in response to the prompting, user input to place the at least one bet; and
placing, in response to the received user input, the at least one bet, wherein the at least one bet is displayed within the graphical interface.

26. The system of claim 19, wherein providing for the at least one bet to be placed comprises:
automatically placing the at least one bet based on identifying the predetermined pattern, wherein the at least one bet is displayed within the graphical interface.

27. The system of claim 19, the operations further comprising:
determining, prior to identifying the predetermined pattern within the hand history, that the predetermined pattern is within a threshold level of occurring within the hand history, based on a comparison of the predetermined pattern to the prior hands of baccarat in the hand history; and
providing, via the graphical interface, a user notification of the determination that the predetermined pattern is within the threshold level of occurring.

28. A method for playing baccarat, the method comprising:
receiving indication of a predetermined pattern for identifying in association with multiple baccarat hands;
displaying a graphical interface for playing at one or more virtual tables of baccarat;
accessing a data structure corresponding to a hand history, the hand history comprising prior hands of baccarat played in association with the one or more virtual tables;
identifying the predetermined pattern within the hand history, based on a comparison of the predetermined pattern to the prior hands of baccarat in the hand history;
providing for at least one bet to be placed based on identifying the predetermined pattern, wherein the at least one placed bet is displayed within the graphical interface;
dealing a hand of randomly-generated cards for the at least one placed bet using a random number generator, wherein the at least one dealt hand is displayed within the graphical interface;
determining, an outcome for the at least one dealt hand based on the randomly-generated cards for the dealt hand and the at least one placed bet; and
displaying, via the graphical interface, the determined outcome for the at least one placed bet.
